(19) United States
(12) Patent Application Publication
(10) Pub. No.: US 2019/0005530 A1
(43) Pub. Date: Jan. 3, 2019

(54) DETERMINING BRAND LOYALTY BASED ON CONSUMER LOCATION

(71) Applicant: INTERNATIONAL BUSINESS MACHINES CORPORATION, ARMONK, NY (US)

(72) Inventors: Jeremy A. Greenberger, Raleigh, NC (US); Jana H. Jenkins, Raleigh, NC (US)

(21) Appl. No.: 15/636,715

(22) Filed: Jun. 29, 2017

(51) Int. Cl. G06Q 30/02

(52) U.S. Cl. CPC G06Q 30/0226; G06Q 30/0238

(57) ABSTRACT

A method is provided for determining brand loyalty based on a user location. A computer determines a pattern of shopping for a user including specific locations of the user within a venue during a shopping event. The computer receives purchase data indicative of items purchased by the user during the shopping event. The computer cross-references the purchase data with the pattern of shopping. The computer determines that the user has a degree of brand loyalty based, at least in part, on the step of cross-referencing, wherein the brand loyalty is a calculated score that varies based on the specific locations of the user within the venue. A marketing campaign is developed based on said degree of brand loyalty of the user. The computer sends output indicative of the degree of brand loyalty to a marketer for developing a marketing campaign.

### TECHNICAL FIELD

The invention relates generally to analyzing consumer characteristics and, more specifically, to making inferences and predictions about consumer behavior based on automatically collected consumer shopping pattern and location data.

### BACKGROUND

Businesses can often benefit from knowledge about the behavior of consumers or prospective consumers. For example, a business may offer certain products or undertake a marketing strategy based on the business' beliefs regarding who the business' consumers are. If these beliefs are inaccurate, though, the business' efforts may be misdirected and the business may fail to maintain old consumers or attract new consumers. Efforts have been previously made at collecting information about consumers who may be consumers and prospective consumers of a business. In some such techniques, a researcher may ask consumers about identities, preferences or behaviors using direct questioning. These questions may be designed to solicit particular information about consumers, such as regions in which a business' consumers live, a socioeconomic grouping of consumers, how often the consumers shop at the business, factors influencing purchasing decisions, and consuming preferences. Written or oral questionnaires, one-on-one interviews, brief point-of-sale questions at the business, focus groups, and telephone or online surveys are examples of ways in which information about consumers can be collected using direct questioning.

Information may be voluntarily provided by consumers when the consumers register for a service, when consumers are registering for discount programs or for services offered commercially by the business. Thus, when a consumer subscribes to services offered by the business, direct questions may solicit information that may be used to acquire information about the individual consumer and for the general class of that business' consumers. The acquired information may then be analyzed to determine information useful to the business.

### SUMMARY

The present invention provides a method is provided for determining brand loyalty based on a user location. A computer determines a pattern of shopping for a user including specific locations of the user within a venue during a shopping event. The computer receives purchase data indicative of items purchased by the user during the shopping event. The computer cross-references the purchase data with the pattern of shopping. The computer determines that the user has a degree of brand loyalty based, at least in part, on the step of cross-referencing, wherein the degree of brand loyalty is a calculated score that varies based at least in part on the specific locations of the user within the venue during the shopping event. The computer sends output indicative of the degree of brand loyalty to a marketer for developing a marketing campaign based on said degree of brand loyalty of said user.

In one embodiment, the computer may further determine that the degree of brand loyalty has met a criterion that dictates that a message is to be sent to the user, and the computer may send the message to the user.

In accordance with another embodiment of the invention, the computer determines a pathway within a venue that was taken by the user when that user was engaged in a shopping event and determining the pattern based, at least in part, on the pathway wherein the pathway comprises a series of specific locations within the venue.

Other forms of the embodiment of the method described above are in a system and in a computer program product.

### BRIEF DESCRIPTION OF THE DRAWINGS

A better understanding of the present invention can be obtained when the following detailed description is considered in conjunction with the following drawings. The accompanying drawings are not intended to be drawn to scale. In the drawings, each identical or nearly identical component that is illustrated in various figures is represented by a like numeral. For purposes of clarify, not every component may be labeled in every drawing. In the drawings:

FIG. 1 illustrates a multi-brand loyalty server operating in a networked environment using a consumer's mobile device according to an embodiment of the present invention.

FIG. 2 illustrates an example process used by the multi-merchant loyalty server to provide loyalty services to consumers according to an embodiment of the present invention.

FIG. 3 is a block diagram of one embodiment of a multi-brand loyalty server.

FIG. 3a is a plan view of a grocery store floor plan with a hypothetical path of travel shown for a hypothetical consumer according to an embodiment of the present invention.

FIG. 3b is a plan view of a grocery store floor plan with a hypothetical path of travel shown for a hypothetical consumer according to an alternate embodiment of the present invention.

FIG. 3c is a plan view of a grocery store floor plan with a hypothetical path of travel shown for a hypothetical consumer according to a further embodiment of the present invention.

FIG. 4 is a flowchart showing a method of retrieving and collecting data related to a consumer shopping event according to an embodiment of the present invention.

FIG. 5 is a continuation of the flowchart of FIG. 4 further showing steps of a method to evaluate a degree of brand loyalty related to a consumer according to an embodiment of the present invention.

FIG. 6 depicts a cloud computing node according to an embodiment of the present invention.

FIG. 7 depicts a cloud computing environment according to an embodiment of the present invention.

FIG. 8 depicts abstraction model layers according to an embodiment of the present invention.

### DETAILED DESCRIPTION

Applicants have recognized and appreciated that there are various disadvantages associated with conventional techniques for determining consumer characteristics, including consumer behavior. Asking a consumer to answer a series of written or oral questions could provide inaccurate or incomplete information. Inferences from this data likewise may be inaccurate or incomplete. For example, a consumer may accidentally underestimate the number of times the consumer visits a business or an amount of time spent at each visit to the business. Or, when asked about a marketing campaign, the consumer may misremember about having seen a billboard or other advertisement. Moreover, there may be a high cost or undesirable delay associated with designing and conducting a survey to generate appropriate data.

Applicants have further recognized and appreciated that automatically-collected consumer location information can lead to more accurate or more complete consumer analytics. Such automated collection could be performed with the permission of individual consumers, but without requiring any actions be taken by the individual consumers. In some embodiments, information about consumers may help businesses make commercial decisions, and specifically, location data collected and analysis performed on that data may be useful in other environments.

Techniques as described herein may provide information for noncommercial organizations. For example, analysis of location information could provide information to non-profit organizations about donors, to politicians about voters, to governments about citizens, or any other suitable type of organization and a consumer related to that organization. It will be appreciated that, as used herein, the term “consumer” is a generic term for a consumer who interacts with an organization or who may interact with an organization, and does not imply, by itself, a commercial relationship between the consumer and the organization. The term consumer may also connote a consumer, a user, or a consumer when applied to the present invention.

Regardless of the purpose for which data is being analyzed, consumers who have opted to participate in a system that gathers data for determining consumer characteristics may carry portable electronic devices that have location-determining capabilities. The determined consumer location, from time-to-time, may be communicated to a consumer analytics platform for analysis. Data about a location of each consumer can be occasionally collected for each consumer as the consumers move while going to work, doing errands, going to social activities, etc. In some embodiments, a consumer analytics platform may obtain location data for a consumer using the devices at time intervals determined on a per-consumer basis. The platform may dynamically adjust the time intervals based on various factors, including a consumer's current location, a current time, and a history of locations visited by a consumer. The intervals between acquiring location information for any consumer may be selected to provide relevant information without requiring excessive power usage by the portable electronic device.

The present invention avoids inaccurate data compilation by marketing agents who try to collect and correlate the consumer's location data to location within a shopping venue. At best, conventional data collection systems receive data regarding consumer location as well as purchase data. However, the conventional systems fail to correlate the collected data to a venue's floorplan or a consumer's path of travel within a venue. Moreover, the conventional systems fail to assign values to different locations along the consumer's path of travel. Thus, the present invention is able to provide individually customizable filtering of consumer data by taking advantage of the technical capability of certain communication networks including location tracking systems and venue floorplans, as well as assigning specific values to different locations, because the present invention will map the consumer's path of travel throughout a venue with the venue's floorplan. Moreover, the system of this invention will accumulate analogous data from different venues for the same consumer without errors inherently derived by data analysts who attempt to compile and correlate similar data that is inherently incomplete due to the lack of mapping consumer purchase data with venue floorplan data.

The present invention matches, correlates or maps consumer locations during a shopping event to the venue floorplan to provide a filtering system that will eliminate errors and problems created by the end user who tries to match and analyze the same data. The filtering system relies not only on the venue's floorplan but with specific values assigned to different locations within the venue. Moreover, the system of this invention will accumulate analogous data from different venues for the same consumer because historical data is saved and cataloged for future use. Lastly, the claimed invention utilizes different scores for different locations throughout the venue. Moreover, the claimed invention not only matches consumer location data to a venue floorplan but it additional assigns scores or values to the locations within the venue to determine a degree of brand loyalty and utilizes the values for calculating brand loyalty. Thus, this invention provide an ordered combination that does not preempt all ways of tracking consumer locations throughout a venue because this invention tracks consumer location or path of travel and cross-references the path of travel to a venue floor plan and further assigns to and utilizes scores related to different locations within the venue. The ordered combination and utilization of the location tracking, floorplan analysis and value analysis is not known in the prior art.

The location data relevant to this invention may be obtained from any suitable source and in any suitable form. As an example, the data may specify geographic coordinates for a consumer's location and a time at which that location data was obtained. In some embodiments, the portable electronic device may be a cellular telephone or may include cellular telephone capabilities, and the data may be acquired through the cell phone network. Such data may be acquired using known interfaces to the cellular telephone system, which may generate data based in whole or in part on cell tower locations relative to the portable electronic device. Such a determination may employ triangulation techniques and may use technology sometimes called assisted GPS. Using the cellular telephone network may reduce the power drain on the portable electronic device, because such techniques as assisted GPS use less power than, for example, GPS. In addition, using a cellular device, or other device that serves a purpose other than data collection, as the source of location data may increase the reliability of consumer data by increasing the likelihood that a consumer will carry the portable electronic device. Location data may also be collected using cameras and other location sensing devices.

Regardless of the specific source or format of the location data, the location data received from multiple consumers may be received and stored for later analysis. When analyzed, this location data could reveal characteristics of consumers. These characteristics may include behaviors, such as the stores at which the consumers shop, how long the consumer spends at each store, which products a consumer viewed, path of travel within a store, and which stores or departments within a store the consumer visited in one overall shopping trip. In addition to revealing commercial behaviors, such an analysis may reveal recreational behaviors. Additionally or alternatively, an analysis of this location information could reveal characteristics such as consumer preferences. Additionally or alternatively, an analysis of this location information could reveal identity characteristics, such as the consumer's home and work locations and roads on which the consumer frequently travels. This information, based on collected factual information and analysis, could be more reliable or more readily obtained than information derived from consumer's answers to questions. There are many methods of collecting relevant consumer information.

By way of example, IBM® Presence Insights enables venues associated with public spaces, healthcare, travel, stadiums, retail stores, and transportation businesses to extend consumer service and support through mobile devices. For example, a retail venue can use Presence Insights to transform the in-store consumer experience by using intelligent location-based technology to engage patrons in near real-time to influence and increase sales. Presence Insight and similar systems also drive unique and personal interactions with patrons, such as personalized marketing promotions.

Integrating Presence Insights with other systems designed to interact with on-site personnel can help one adjust associate and staff coverage, which may be based on patron traffic. IBM Presence Insights works by detecting mobile devices that are communicating through radio signals using various protocols. Presence Insights supports Bluetooth Low Energy (BLE), Wi-Fi 802.11 on 2.4 GHz and 5 GHz radio communication protocols. When a mobile device is detected using one of the supported protocols, a Globally Unique Identifier (GUID) is assigned for the mobile device. The GUID can be the MAC address for the mobile device. The mobile device is tracked as the mobile device moves through the venue. All personally identifiable information (PII) including the MAC address or GUID is encrypted by using a public key that is provided by the vendor to ensure that the consumer data is secure. As the mobile device moves through the venue, notifications can be triggered and sent enabling other back-office systems to take action.

IBM Presence Insights includes pre-configured reports that analyze mobile device movement inside a venue; specifically, the device owner's trajectory and movement behavior as the movement relates to defined site and zone regions. The reports enable sophisticated analysis of the site's consumer data, such as movement patterns, site traffic, and owner preferences.

Through brand loyal, consumers form a solid base on which companies can build brand profitability. Brand loyalty is difficult for marketers to identify because the marketers cannot obtain a general profile that applies to all categories. Consumers that are loyal to a particular brand for mayonnaise, for example, might not be for ketchup.

This invention proposes a system and method to help identify brand loyalty based on the location of how a consumer travels in a store. This system will be able to take into account location-based variants, such as the path of travel, location of similar items, order of seen similar products, etc. By understanding the shopping trends and brand loyalty, the invention may provide consumers with an enhanced shopping experience and highly targeted promotions.

In one embodiment of the invention, the consumer's shopping history may be a prerequisite to help fine tune the accuracy of the invention; i.e., consumer would have needed to shop at least once in a venue or the system of the present invention would need to receive purchase history from some another system. The shopping history is stored in a suitable database.

In accordance with this invention, a consumer would shop in a venue outfitted with a system such as IBM® Presence Insights and/or IBM Marketing Cloud. The system enable venues such as retail stores, hospitals, airports, stadiums, concert halls, hotels and other areas where people gather to extend consumer service and support through mobile devices. A retail store, for example, can use such technology to transform the in-store consumer experience by using intelligent location-based technology to engage consumers in near real time. The system also helps venue operators to gain insight into consumer behavior in the venue and deliver timely, contextually relevant interactions. IBM® Marketing Cloud is a cloud-based digital marketing platform that provides email marketing, lead management and mobile engagement solutions. Other similar and/or complementary technologies may be employed in accordance with the present invention.

Using location detecting technology, a consumer's actions of selecting, viewing, and/or purchasing a specific consumer item would be detected. The system monitors and records the path traveled by the consumer and determines if the consumer grabs, views, or purchases similar products to the products previously purchased. Some examples of technologies that can detect these actions of the consumer include:

Wi-Fi Triangulation or Wi-Fi Positioning Systems (WPS) or WiPS/WFPS is used where GPS and GLONASS are inadequate due to various causes including multipath and signal blockage indoors. Such systems include indoor positioning systems. Wi-Fi triangulation or positioning takes advantage of the rapid growth in the early 21st century of wireless access points in urban areas. The most common and widespread localization technique used for positioning with wireless access points is based on measuring the intensity of the received signal and the method of “fingerprinting”.

Video Cameras are typically portable handheld or mounted cameras for recording moving images in digital memory or on videotape.

Bluetooth Low Energy (BLE) Beacons: BLE Beacons are hardware transmitters; i.e., a class of low energy devices that broadcast an identifier to nearby portable electronic devices. The technology enables smartphones, tablets and other devices to perform actions when in close proximity to a beacon. BLE beacons may provide an indoor positioning system, which helps smartphones determine an approximate location or context. With the help of a Bluetooth beacon, a smartphone's software can approximately find the phone's relative location to a Bluetooth Beacon in a store. Brick and mortar retail stores use the beacons for mobile commerce, offering consumers special deals through mobile marketing and can enable mobile payments through point of sale systems.

Bluetooth beacons differs from some other location-based technologies as the broadcasting device (beacon) is only a 1-way transmitter to the receiving smartphone or receiving device, and necessitates a specific app installed on the device to interact with the beacons. This ensures that only the installed app (not the Bluetooth beacon transmitter) can track users as the users passively walk around the transmitters.

Quick Response (QR) Codes are a type of matrix barcode (or two-dimensional barcode), which consists of black squares arranged in a square grid on a white background, which can be read by an imaging device such as a camera, and processed using Reed-Solomon error correction until the image can be appropriately interpreted. A barcode is a machine-readable optical label that contains information about the item to which the barcode is attached. A QR code uses four standardized encoding modes (numeric, alphanumeric, byte/binary, and kanji) to efficiently store data; extensions may also be used.

Radio Frequency Identification (RFID) uses electromagnetic fields to automatically identify and track tags attached to objects. The tags contain electronically stored information. Passive tags collect energy from a nearby RFID reader's interrogating radio waves. Active tags have a local power source such as a battery and may operate at hundreds of meters from the RFID reader. Unlike a barcode, the tag need not be within the line of sight of the reader, so the tag may be embedded in the tracked object.

In accordance with this invention, a consumer would check out as the consumer would normally check out of a retail store. The system would look at items the consumer purchases, and the system, for each item, would determine if the “type” or “category” of product(s) has been purchased by consumer before. (e.g. cookies, chips, soda). If the answer is “no,” the system would determine that no brand loyalty record exists. If the answer is “yes,” the system would determine if the brand viewed but not purchased/picked up has been purchased before.

By way of example, the system next, or each item, would look at the path the consumer travelled relative to: (1) the order of the related products a consumer passes by (e.g. did the consumer buy the first item of this type of food the consumer saw? e.g., the first type of cookie the consumer saw after walking in.); (2) location of products that are cheaper (e.g. did the consumer see a product that was cheaper?); (3) location of products that are in the same category (e.g. did the consumer go to the cookie aisle to buy Oreos or did the consumer just purchase the item on an endcap display?); (4) location of products that are higher or lower quality; (5) overall location travelled in store profile (e.g. does a consumer like walking all of the way to the back of the store?); (6) locations of promotional items in the store (e.g. where the promotional banners are?).

If the consumer is consistent on the way the consumer determines the product the consumer purchases, the system would determine there is an increase confidence on brand loyalty. If the consumer is not consistent in the way the consumer determines the product the consumer purchases, the system would determine there is a decrease confidence on loyalty.

In accordance with this invention, a multi-brand loyalty server provides real-time product or service suggestions to consumers based on transaction data coupled with location data. The multi-brand loyalty server receives consumer location information and transaction data from consumer history. A loyalty event, such as a promotion, a specific advertisement, or reward for a suggested product or service, is determined based on the transaction data. Information about a suggested merchant and the loyalty event is sent to a remote or mobile device operated by the consumer in order to encourage him to make a purchase from the suggested merchant.

The present invention, in conjunction with other known systems, is designed to interact with on-site personnel to track consumer data. In one embodiment, the invention works by detecting mobile devices that are communicating through radio signals using various protocols. For example, the invention may utilize Bluetooth Low Energy (BLE), Wi-Fi 802.11 on 2.4 GHz and 5 GHz radio communication protocols. When a mobile device is detected using one of the supported protocols, a Globally Unique Identifier (GUID) is assigned for the mobile device. The GUID can be the MAC address for the device. The mobile device is tracked as the mobile device moves through the venue. All personally identifiable information (P II) including the MAC address or GUID is encrypted by using a public key that is provided by a vendor to ensure that the consumer data is secure. As the device moves through the venue, notifications can be triggered and sent enabling other back-office systems to take action.

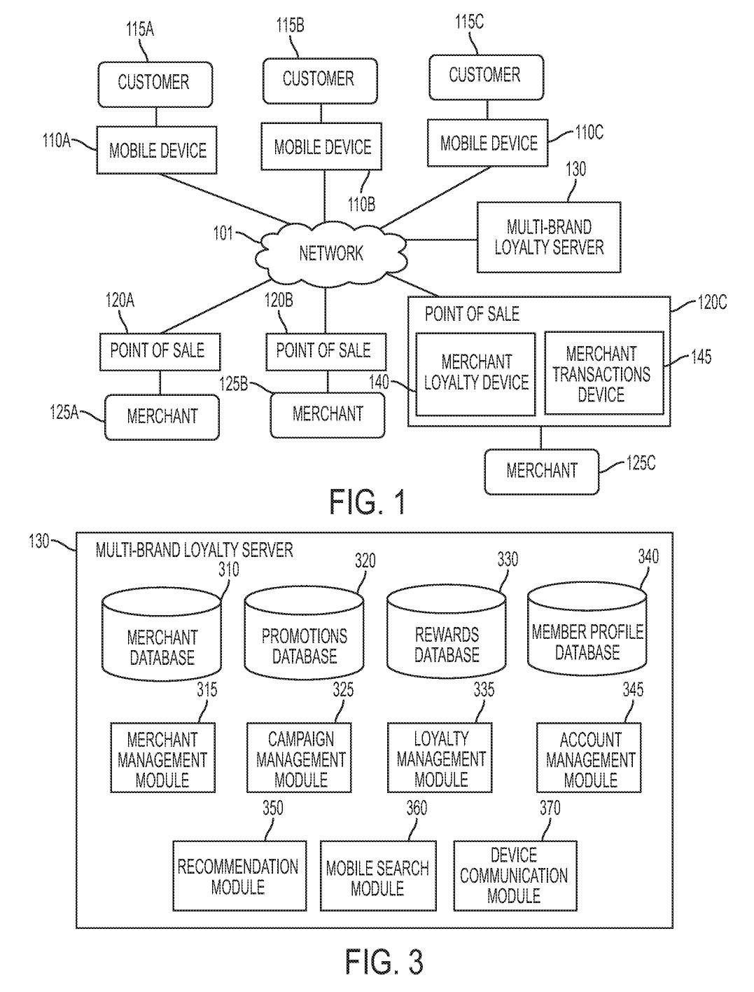

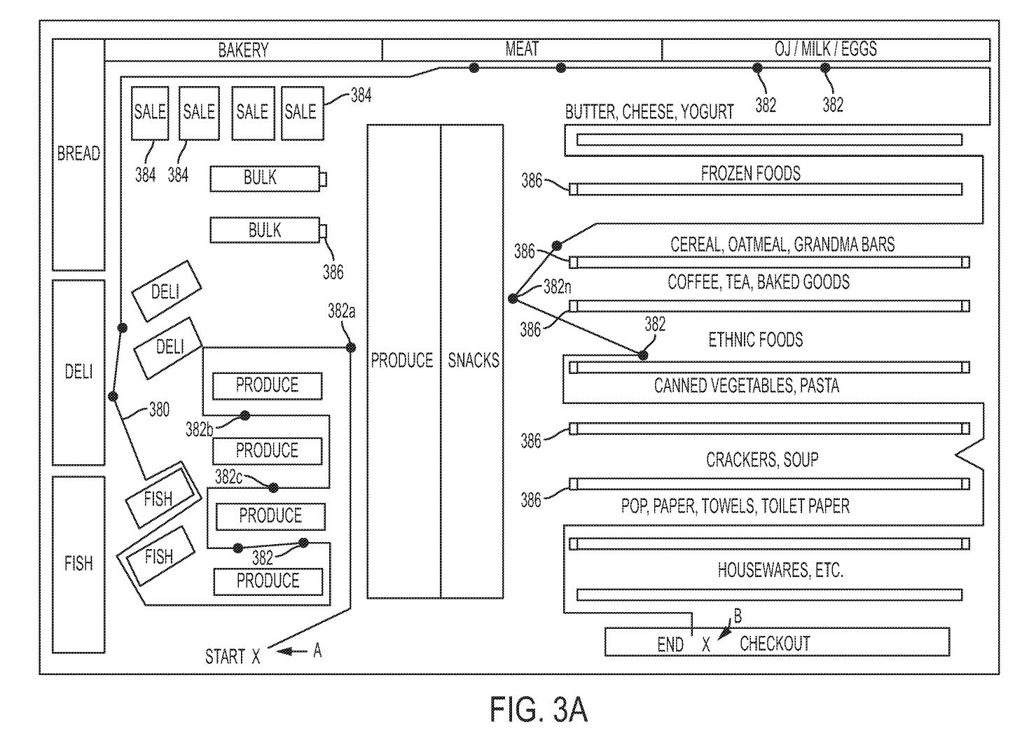

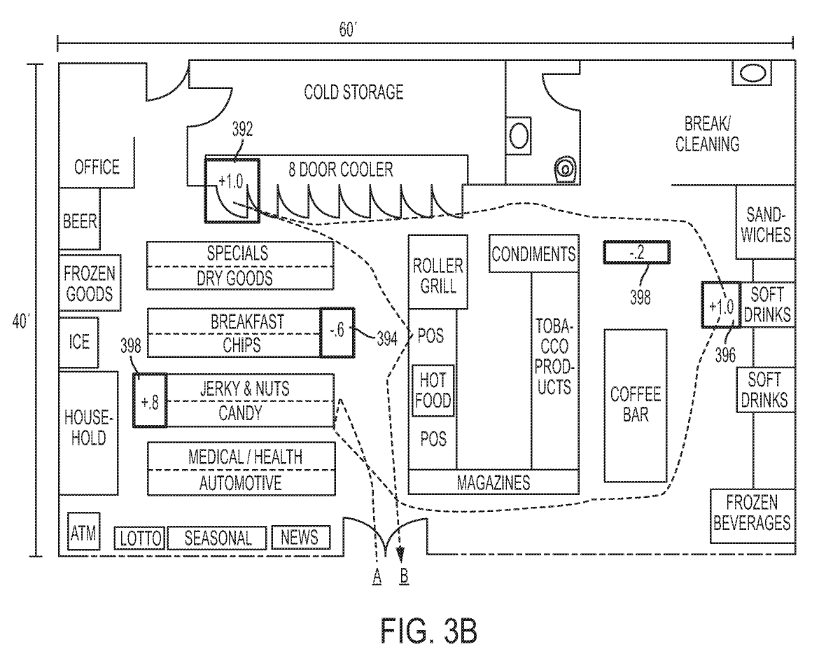

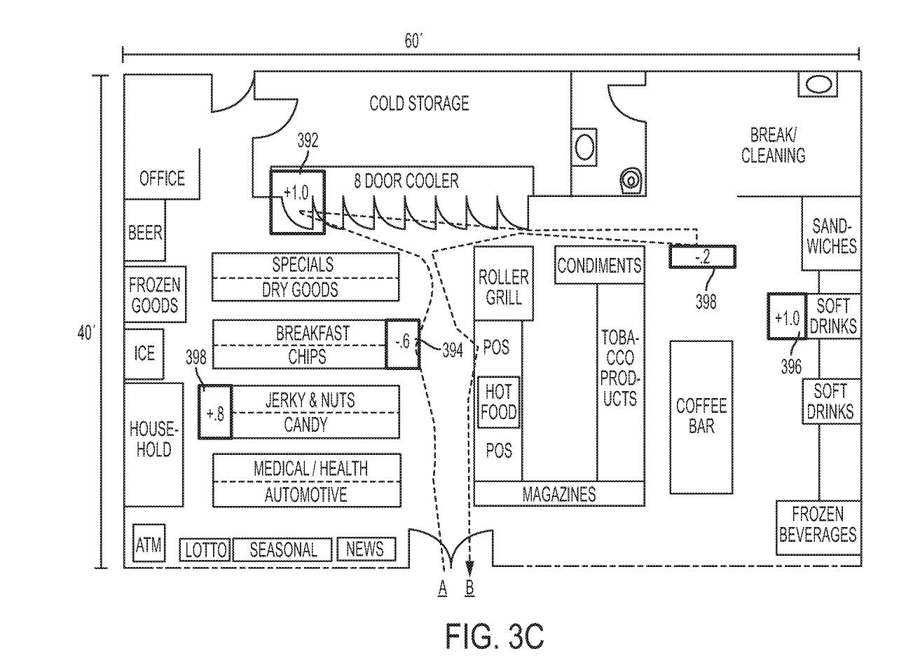

The term “system” as used herein refers to at least one of the network 101 of FIG. 1 and the loyalty server 130 of FIG. 3. These components work in conjunction to achieve the benefits of the present invention. As described above, the loyalty server 130 of FIG. 3 interacts with the network 101 to receive and transmit data to and from the consumers 115A, 115B, 115C; the mobile devices 110A, 110B, 110C; the merchants 125A, 125B, 125C; and point of sales components 120A, 120B, 120C.

The invention may include pre-configured reports that analyze mobile device movement inside a venue. Specifically, the device owner's trajectory and movement behavior as the trajectory and movement relates to defined site and zone regions may be monitored and recorded. The invention is not limited to a user's mobile device but may include additional data tracking techniques such as described above; e.g., WPS, video cameras, BLE, QR Codes, RFID tags, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 illustrates a multi-brand loyalty server operating in a networked environment using a consumer's mobile device according to an embodiment of the present invention. Here, the multi-brand loyalty server 130 is connected via a network 101 with a plurality of consumers 115A, 115B, 115C using respective mobile devices 110A, 110B, 110C and a plurality of merchants 125A, 125B through point of sale devices 120A, 120B, 120C. The merchants have subscribed to a loyalty service, the purpose of which is to drive traffic between the different merchants. That is, to build “brand” loyalty to the network of merchants. This type of loyalty service is different from conventional offerings because the service spans multiple merchants/brands.

The mobile devices 110A, 110, B, 110C may be portable device with the ability to communicate with the multi-brand loyalty server 130, such as smart phones, tablets, cell phones, etc. in order to track location of the consumer.

In one embodiment of the invention, a consumer 115A, 115B, 115C operating a mobile device 110A, 110B, 110C can receive and view messages from the multibrand loyalty server 130. The messages may be communicated in real-time to the mobile device 110A, 110B, 110C through any applicable communication means, including through Short Message Service (SMS), email, mobile application (app), etc. The notification from the multi-brand loyalty server 130 contains marketing information promoting a product or service offered by one or more suggested merchants (which will generally be referred to as “loyalty events”), and the loyalty events are predicted to be relevant to the user at the current time and location.

Based on the information in the messages, the consumer may be motivated to visit one or more of the suggested merchants to take advantage of one or more of the loyalty events. The messages may take the form of advertisements, coupons with discounts or other promotions to motivate action from the user. Since the loyalty events are delivered in real-time, the loyalty event may also be time-limited to motivate immediate action from the user.

Before being able to receive and view messages from the multi-brand loyalty server 130, each consumer 115A, 115B, 115C may need to register or subscribe to a multi-brand loyalty service. After subscribing, the consumer may obtain a membership card used to identify the consumer when making a transaction or redeeming a promotion or reward.

The point of sale devices 120A, 120B, 120C are operated by merchants such as product retailers, service providers, etc., who have employed the techniques of this invention. The point of sale devices 120A, 120B, 120C may be any machine capable of sending data to the multi-brand loyalty server 130, such as, for example, personal computers, dedicated point of sale devices (e.g., credit card readers), tablets, electronic cash registers, vending machines, etc.

The point of sale devices 120A, 120B, 120C send transaction data containing information about transactions conducted between users and merchants, to the multi-brand loyalty server 130. The transaction data is sent from the point of sale device 120A, 120B, 120C to the multi-brand loyalty server 130 as the transaction is conducted between the user and the merchant, or soon after the transaction has been completed. In this way the multi-brand loyalty server 130 is given real-time or nearly real-time information about a transaction. In some embodiments, the multi-brand loyalty serve 130 receives transaction data from a merchant 125A, 125B, 125C within a threshold amount of time (e.g., 1 minute) after the transaction between the merchant 125A, 125B, 125C and the consumer 115A, 115B, 115C has been completed. The transaction data may contain information describing products and services that have been purchased by the user in the transaction with the merchant. The transaction data may also identify the location of the store where the transaction took place, or the multi-brand loyalty server may determine this based on other information, such as information provided by the merchant at registration for the loyalty service.

The point of sale devices 120A, 120B, 120C also provide consumer identification to the multi-brand loyalty server 130. For example, consumers may present a membership card, a membership number, a barcode of the membership number, a phone number, or other loyalty service identification. For convenience, the device that provides transaction data will be referred to as the merchant transaction device 145 and the device that provides consumer identification will be referred to as the merchant loyalty device 140. This is strictly for purposes of explanation. The merchant transaction device 145 and the merchant loyalty device 140 could be implemented by a single device rather than as two separate devices.

The network 101 provides a communication infrastructure between the mobile device 110A, 110B, 110C, the point of sale devices 120A, 120B, 120C, and the multi-brand loyalty server 130. The network 101 may include cellular networks, the Internet, a Local Area Network (LAN), a Metropolitan Area Network (MAN), a Wide Area Network (WAN), a mobile wired or wireless network, a private network, a virtual private network, etc.

The multi-brand loyalty server 130 receives transaction data from the point of sale devices 120A, 120B, 120C and generates messages containing product or service promotions for suggested merchants that are sent back to the mobile device 110A, 110B, 110C in real-time. These messages may be in the form of advertisements, coupons, mobile alerts, etc. The messages may be sent to the user devices as SMS (text), email, through a mobile app, or any other mobile communication method. Details of the multi-brand loyalty server are described in conjunction with the description for FIG. 3.

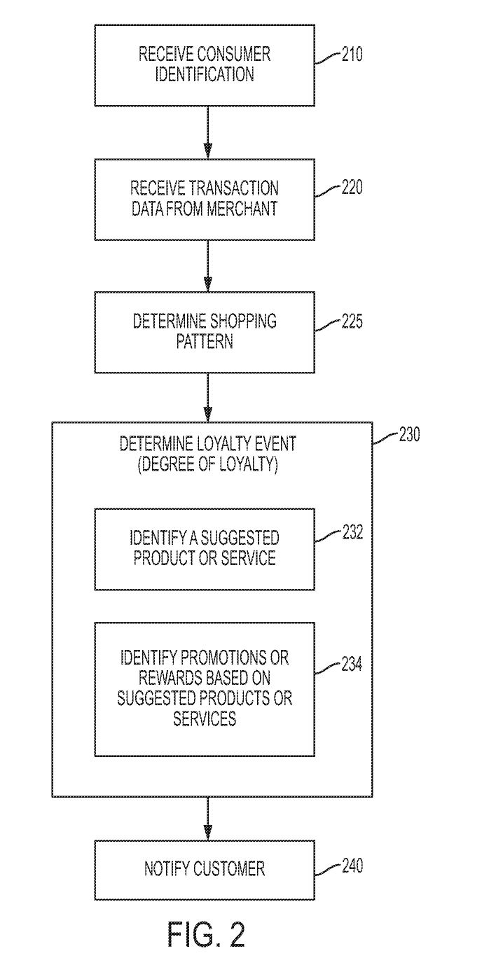

FIG. 2 illustrates an example process used by the multi-merchant loyalty server to provide loyalty services to consumers according to an embodiment of the present invention. In the illustrated process, the multi-brand loyalty sever 130 receives at step 210 consumer identification information from a merchant 125A, 125B, 125C. In one embodiment, the system automatically detects the user's identification details; for example, via the mobile device 110A, 110B, 110C. When a mobile device 110A, 110B, 110C is detected using one of the supported protocols, a Globally Unique Identifier (GUID) is assigned for the device. The GUID can be the MAC address for the device. The mobile device 110A is tracked as the mobile device 110A moves through the venue. All personally identifiable information (P II) including the MAC address or GUID is encrypted by using a public key that is provided by a vendor to ensure that the consumer data is secure. As the mobile device 110A moves through the venue, notifications can be triggered and sent enabling other back-office systems to take action. In another embodiment, the merchant 125A, 125B, 125C obtains the consumer information by scanning or swiping a membership card. In other embodiments, the merchant 125A, 125B, 125C may ask a consumer 115A, 115B, 115C for identification information such as phone number, address, driver license number, and the like. In yet other embodiments, the consumer identification may be derived from the payment method used by the consumer 115A, 115B, 115C, such as a credit card number. Embodiments of the invention may use a merchant loyalty device 140, located on premises at the merchant 125A, 125B, 125C, to retrieve the consumer identification and send the consumer identification to the multi-brand loyalty server 130. In one embodiment, the merchant loyalty device is embedded in, or is part of, the point of sale device 120A, 120B, 120C.

Transaction data is also received from the merchant 125A, 125B, 125C at step 220. Transaction data may include details of how a consumer travels in a store. This system, via the merchant database 310, member profile database 340, mobile search module 3670, etc., will be able to take into account location-based variants, such as the path of travel, location of similar items, order of seen similar products, etc. Transaction data may comprise one or more products or services purchased by the consumer 115A, 115B, 115C. Using location detecting technology, a consumer's actions of selecting, viewing, and/or purchasing a specific consumer item would be detected and recorded as transaction data. Moreover, the device communication module 370 monitors and records the path traveled by the consumer and determines if the consumer grabs, views, or purchases similar products to the products previously purchased. Transaction data may also comprise information related to the merchant 125A, 125B, 125C where the consumer 115A, 115B, 115C made the transaction. In some embodiments, the transaction data is sent from a merchant transaction device. In one embodiment, the merchant transaction device is embedded in, or is part of, the point of sale device 120A, 120B, 120C.

Based on the data collected at step 220, the loyalty server 130 next at step 225 determines a shopping pattern or shopping patterns of the consumer. For example, the loyalty server 130 would look at the consumers patterns such as: (1) the order of the related products a consumer passes by (e.g. did the consumer buy the first item of this type of food the consumer saw? e.g., the first type of cookie the consumer saw after walking in.); (2) location of products that are cheaper (e.g. did the consumer see a product that was cheaper?); (3) location of products that are in the same category (e.g. did the consumer go to the cookie aisle to buy Oreos or did the consumer just purchase the item on an endcap display?); (4) location of products that are better/worse quality; (5) overall location and pathway travelled in store profile (e.g. does a consumer like walking all of the way to the back of the store?); (6) locations of promotional items in the store (e.g. where the promotional banners are?).

Next, the loyalty server 130 determines at step 230, in real-time, a loyalty event. Loyalty events are based on the consumer's location and how the consumer travels through a store. Based on the loyalty event, the system, e.g., the promotions database 320, at step 234 may identify a suggested product or service at step 232 and/or identify promotions and/or rewards based on the suggested products or services identified at step 232. The network 101 and loyalty server work together to take into account location-based variants such as path of travel, location of similar consumer items, viewing order of similar consumer items, cost of similar items, etc. A loyalty event is related to products historically viewed and/or purchased by the consumer as well as patterns of behavior related to promotional items, promotional displays, competing products, associated products, etc.

Other examples of loyalty events may include purchasing an item that is included in the consumer's purchase history, and/or may include promotions and rewards based on the consumer's actions during a shopping event. Examples of promotions are a price deal, a coupon, rebate, or the like, that the consumer 115A, 115B, 115C can use at a second merchant to obtain a product or service at a discounted price. For example, a promotion may be a coupon for a 50% discount at another specific merchant 125A, 125B, 125C. Promotions may be specific to one or more merchants, one or more products at any merchant that offers the product, or one or more products in a specific merchant, etc.

One type of reward is a redeemable offer in which the consumer can use points or stars that were obtained for purchasing products or services at one or more merchants 125A, 125B, 125C. Rewards may also be specific to one or more merchants, one or more products at any merchant offering the product, or one or more products in a specific merchant. Promotions and rewards may need to be used or redeemed within a certain amount of time (e.g., within 24 hours) of the transaction between the merchant 125A and the consumer 115A.

In one embodiment, the loyalty event is for a merchant 125B different from the merchant 125A where the consumer is currently making a transaction. The merchant 125B associated with the loyalty event may be selected based on the merchant's geographic relation with merchant 125A (e.g., based on a distance between the two merchants, or whether both merchants are located in the same mall). In other embodiments, the loyalty event is for a product at the current merchant 125A to entice the consumer 115A, 115B, 115C to keep shopping at that merchant.

In some embodiments, the loyalty event may be information regarding a product or service at a second merchant, where the product or service is related to the transaction between the merchant 125A, 125B, 125C and the consumer 115A, 115B, 115C. In some embodiments, the loyalty event may include information regarding a product that is only available to consumers using the multi-brand loyalty service.

FIG. 3 is a block diagram of one embodiment of a multi-brand loyalty server. In the illustrated embodiment, the multi-brand loyalty server 130 includes a device communication module 370, a recommendation module 350, a mobile search module 360, an account management module 345, a member profile database 340, a merchant management module 315, a merchant database 310, a campaign management module 325, a promotions database 320, a loyalty management module 335 and a rewards database 330.

The device communication module 370 handles communication with the mobile devices 110A, 110B and the point of sale devices 120A, 120B. The device communication module 370 enables the multi-brand loyalty server 130 to perform common communications-related operations on messages that are sent and received, such as encryption/decryption, compression/decompression, authentication, etc. Transaction data from point of sale devices 120A, 120B, 120C is received by the device communication module 370 and sent to the recommendation module 350. Notifications of loyalty events (e.g., messages with product recommendations) generated by the recommendation module 350 are sent by the device communication module 370 to the mobile devices 110A, 110B, 110C.

The account management module 345 enables users operating the mobile devices 110A, 110B, 110C to establish a user account with the multi-brand loyalty server 130 and is configured to update the member profile database 340. The account management module 345 may receive information about users operating the mobile devices 110A, 110B, 110C, either from the mobile devices 110A, 110B, 110C or from other sources such as directories, retailers, credit agencies, banks, etc. Some user information may be provided by users when the user registers or establishes an account with the multi-brand loyalty server 130. Other information may be collected passively by the account management module 345 over the course of time, for example as transaction data concerning a user is sent to the multi-brand loyalty server 130 from merchants.

The member profile database 340 stores information about users that has been received or collected by the account management module 345. Information about a user may be aggregated and stored by the account management module 345 in a user profile for that user. The user profile for a user may contain information about the user such as age, sex, address, product preferences, store preferences, purchase history, stores frequented, etc.

The merchant management module 315 enables merchants to establish an account with the multi-brand loyalty server 130. Merchants that subscribe to the loyalty service (which usually requires the merchants to register or otherwise establish an account with the multibrand loyalty server 130) are referred to as merchants. In one embodiment, the network of merchants is limited to merchants located within a certain geographic area (such as a certain city, or metropolitan area). In other embodiments, the merchant network is limited to merchants that offer luxury brands and/or luxury services.

The merchants operate the point of sale devices 120A, 120B, 120C that send transaction data to the multi-brand loyalty server 130. When a merchant establishes an account with the multi-brand loyalty server 130, the merchant management module 315 receives business information from the merchant. The business information provides a description of the merchant's business that can be used to determine when users should be directed to that merchant. For example, the business information provided to the multi-brand loyalty server 130 may include information about products or services offered by the merchant, locations for stores operated by the merchant, store hours for the merchant, etc. The information for each merchant is stored in records in the merchant database 310. The merchant management module 315 may also receive information from merchants describing advertisements, coupons, and other inducements offered by those merchants. When it is determined that a user may be interested in products or services offered by a particular merchant, that merchant's coupons or advertisements may be sent in a message to the consumer. The process for determining when to send a particular merchant's information to a user is described in more detail herein.

The recommendation module 350 receives transaction data about a transaction between a user and a merchant, from a point of sale device 120A operated by that merchant, and generates a message containing promotional information about a product or service offered by a suggested merchant, which is relevant to the user and which can be sent in real-time to a mobile device 110A, 110B, 110C operated by the user. The communication to and from the mobile device 110A, 110B, 110C and point of sale device 120A, 120B, 120C can be conducted via the device communication module 370, as described earlier, and can take the form of emails, SMS messages, push notifications through a mobile app, etc. The recommendation module 350 typically utilizes information in the member profile database 340 and the merchant database 310, in addition to the transaction data and the consumer identification, to determine the product or service that is relevant to the user. The recommendation module 350 is discussed in more detail below.

The mobile search module 360 indexes documents (such as promotions or rewards offered by merchants) and maintains a content index. When search queries are received from mobile devices 110A, 110B, 110C operated by consumers 115A, 115B, 115C, the mobile search module 360 identifies query results that are referenced to indexed documents that are relevant to the query strings. The query results may be sent back to the mobile device 110A, 110B, 110C via the device communication module 370.

The promotion database 320 stores information about promotions offered by merchants through the multi-brand loyalty server 130. Information about promotions may include a description of the promotion, a time frame during which the promotion is valid, a targeting criteria limiting which users are eligible to receive the promotion, etc.

The rewards database 330 stores information about rewards offered by merchants or by the loyalty service through the multi-brand loyalty server 130. Information about rewards may include a description of the reward, a number of loyalty points or stars required to redeem the reward, a time frame during which the reward is valid, etc. The promotion database 320 and the reward database 330 are updated by the campaign management module 325.

The loyalty management module 335 updates an amount of points or stars available to each consumer based on transaction data received from merchants. In some embodiments, the loyalty management module 335 increases the number of points or stars available to a consumer each time the consumer performs a transaction using the multi-brand loyalty service, and the loyalty management module 335 decreases the number of points or stars available to the consumer each time the consumer uses the consumer's available points or stars to take advantage of a reward offered by a merchant. For example, the loyalty management module 335 may increase the amount of points a consumer has by one point for every dollar the user spends using the multi-brand loyalty service. As another example, the loyalty management module 335 may decrease a certain amount of points (e.g., 1000 points) when the consumer redeems a movie ticket using a reward offered by a movie theater.

FIG. 3a is a plan view of a grocery store floor plan with a hypothetical path of travel shown for a hypothetical consumer exemplifying an embodiment of the present invention. The floor plan of FIG. 3a is intended as exemplary only to show a typical path of travel 380 for a hypothetical consumer from point A at an entrance of a retail grocery store to point B at a checkout. As with typical consumers, the path does not include every aisle or area of the store.

By way of example, the path of travel 380 has been marks with pick-up points 382a, 382b, 382c, . . . , 382n (designated generally as 382 or with a bullet point) where the consumer adds an item to a grocery cart. FIG. 3a also illustrates promotional points of sale 384 and end cap display location 386. Of course, the specific locations of these promotional areas 384, 386 are provided by way of example only for illustrative purposes.

According to the present invention, the consumer or consumer travels along a path of travel 380 as shown on the floor plan of FIG. 3a and selects item for purchase at points 382, 382a, 382b, 382c, . . . 382n. Typically, these items are placed in a shopping cart or basket for checkout at point B. Because the system via the member profile database 340 knows the item purchased at check out and the location of purchase (e.g., point of purchase 382) of each item, the loyalty server 130 can analyze and cross-reference the data collected regarding the path of travel and items purchased at checkout. By knowing the path of travel, the loyalty server 130 may also analyze and evaluate whether the consumer chose items at a promotional area 384, 386 or along an aisle of the floor plan. The loyalty server 130 will also be able to evaluate competing items that the consumer passed but did not purchase. Likewise, the loyalty server 130 will know which aisles or areas of the store the consumer did not traverse. The path of travel 380 may be detected by any means described above including proximity sensors located on the consumer's mobile phone, video cameras, Bluetooth, etc. The pick-up points 382 may likewise be known from historical data, may be collected if the store utilizes smart shelf systems that detect when items are picked up from a shelf or display, may be detected using RFID tags, or any other suitable detection means.

The areas of interest to the consumer, the specific products purchased by the consumer, the product brands, and the areas containing purchased items may be tallied to denote affinity zones and/or affinity products and product types associated with to a particular consumer. Affinity zones are defined by trends of the consumer based on a number of times the consumer returns to the same location. Likewise, data collected related to purchases from promotional areas 384, 386 or related to a specific brand or product type may be indicative of a shopping preference for the consumer. For example, the consumer may show an affinity toward purchasing item displayed on an end cap display 386. Similarly, a particular consumer may skip end cap displays 386 in favor of specific brands located on the regular aisles on the store. A consumer, likewise, may have an affinity toward fish over meat or diary, or the consumer may prefer organic products over non-organic products. Regardless, the system (i.e., network 101 and loyalty server 130) utilizes the location of the consumer in conjunction with location of items purchased to assess patterns for each individual consumer or consumer. These patterns may be collected and analyzed for marketing purposes as will be described in more detail below.

For example, the loyalty management module 335 of the system according to the invention may determine a loyalty score based on collected data. A score may for example be a scale from one (1) to ten (10) based on statistical analysis of the data collected with respect to the shopping patterns of a particular consumer (e.g., purchase locations within a store, affinity for sales, affinity for brands, etc.) described herein. With the loyalty score, the loyalty server 130 may generate promotional ads, messages, giveaways, bonuses, rewards, etc. that are directed to the consumer via, for example, a text message or other electronic advertisement.

FIG. 3b is a plan view of a grocery store floor plan with a hypothetical path of travel shown for a hypothetical consumer according to an alternate embodiment of the present invention. As with the floorplan of FIG. 3a, the floor plan of FIG. 3b is intended as exemplary only to show a typical path of travel for a hypothetical consumer from point A at an entrance of a retail grocery store to point B at a checkout. FIG. 3b shows the location of the primary product 392 as well as different relevant locations depending on the type of factors the retailer wishes to monitor. For example, FIG. 3b illustrates locations of associated products 394 which may be products that are typically bought together or even needed in order to fulfill a promotional discount (e.g. one must buy 2 of X products in order to get 50% off Y product). FIG. 3b also illustrates locations of competing products 396 (e.g. Coke® would be a competitor of the Generic Cola). Lastly, FIG. 3b illustrates locations of promotional billboards 398 (e.g. there is a large promotional billboard in the location that may entice a consumer to buy a particular product). These are not the only locations that the retailer might want to monitor on, but the exemplary embodiment of FIG. 3b will use these examples for illustration.

Next, the loyalty management module 335 of this invention will, for example, assign a value to each relevant location. The values will be used to determine a calculated score indicative of a degree of brand loyalty. The value assignment can be done various ways but an example will be described below. As shown in FIG. 3b, a point value has been assigned to each relevant location. For example, a point value of +1 is assigned to the primary product 392, a value of +1 is assigned to the competing product, a value of -0.6 is assigned to the associated product, and point values of −0.8 and −0.2 are assigned to the billboards. On a scale of 0-1 where 1 is the highest loyalty, the loyalty management module 335 would add all of the values together for the locations there the consumer travels, then, the values are averaged. For the example of FIG. 3b, the path traveled for Coke® is illustrated or mapped and the consumer actually passed by the competing product 396 (e.g., generic cola) and the path is totaled to 2 (i.e., +1 for the primary product and +1 for the competing product) and divided by 2 to achieve a value of 1. The loyalty server 130 would then add 1 to the consumer's current history of affinity for the primary product 392; i.e., the affinity score.

FIG. 3c is a plan view of a grocery store floor plan with a hypothetical path of travel shown for a hypothetical consumer according to a further embodiment of the present invention. As with the floorplan of FIGS. 3a and 3b, the floor plan of FIG. 3c is intended as exemplary only to show a typical path of travel for a hypothetical consumer from point A at an entrance of a retail grocery store to point B at a checkout. In the example of FIG. 3c, the consumer follows a path of travel from A to B while passing by the associated products section 394 and the promotional billboard 398. According to this example, the consumer's affinity score is calculated based on a path of travel where a value of +1 is assigned to the primary product 392, a value of −0.2 is assigned to the associate product 394, and a value of −0.6 is assigned to the promotional billboard 398. The calculation for the affinity number for the example of FIG. 3c is (1+(−0.2)+(−0.6)) for a total value of 0.2. This value is used by marketer to assess a consumer's affinity for a specific product or brand based on the path of travel of the consumer with an emphasis on which competing products were viewed and/or purchased as well as associate products and promotional areas and billboards are viewed by the consumer. Essentially, positive areas of interest for the consumer are weighed against negative areas of interest for the consumer to arrive at an affinity score for a specific brand or product. Other methods may be employed to monitor a consumer's path of travel through a store to determine an affinity for particular products and/or brands.

Therefore, the degree of brand loyalty as used herein relates to calculated numerical value or score based on the relationship between specific locations of a consumer throughout a venue, such as a grocery store, and the products viewed and/or purchased by the consumer. The degree of brand loyalty will be calculated based on a variety of factors such as the number of competing products viewed and/or purchased by the consumer, the frequency a consumer views and/or purchased items on sale, the related products viewed and/or purchased by a consumer, as well as other factors determined by those of skill in the art of marketing that may indicate an affinity toward specific product and/or brand. Once a degree of brand loyalty has been calculated for a specific consumer as it relates to a specific product and/or brand, then the calculated numerical value will be compared with a predetermined loyalty criteria to assess whether or not to send a promotional message or whether or not to develop a specific marketing campaign directed to the consumer in question. In the examples provided above, the system will assign point values to various locations throughout the venue in question. Locations in the venue that tend to show an affinity toward a product or brand will increase the numerical value defining the degree of brand loyalty and other locations in the venue that tend to show less affinity toward a product or brand will decrease the numerical value defining the degree of brand loyalty.

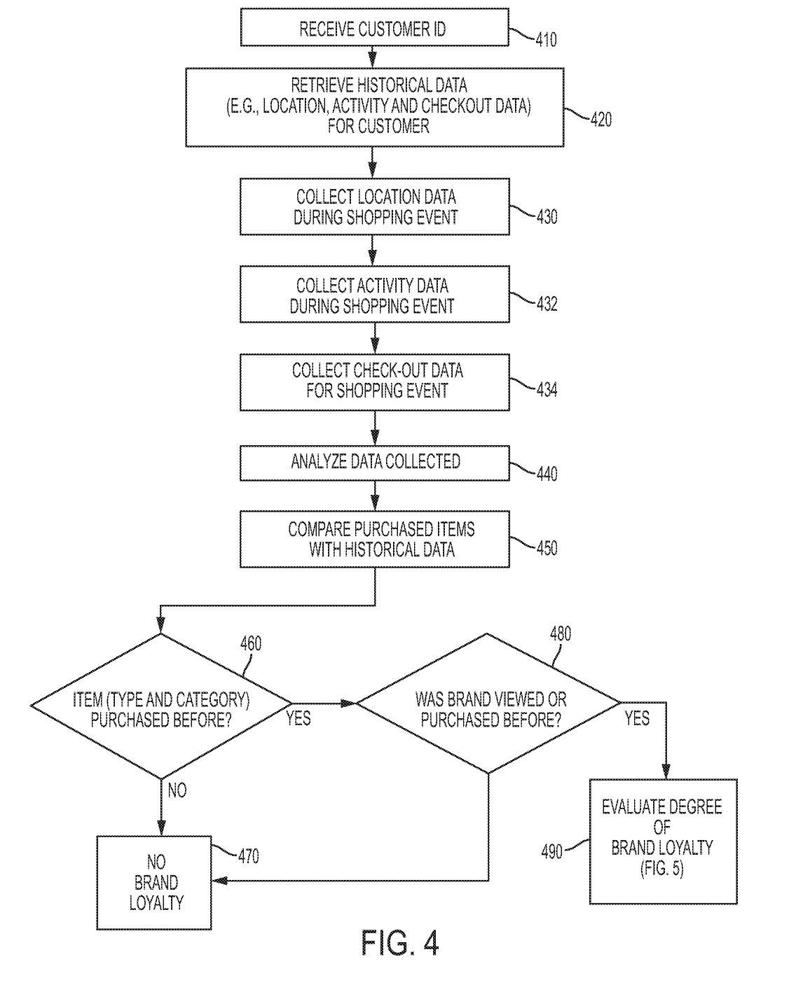

FIG. 4 is a flowchart showing a method of retrieving and collecting data related to a consumer shopping event according to an embodiment of the present invention. With reference to FIG. 4, the network 101 would access consumer database, such as the loyalty server 130 and member profile database 340 of FIG. 3. At the outset, the network 101 at step 410 would receive consumer identification information from member profile database 340 in order to link historical data for the consumer with a real-time shopping experience for the same consumer. At step 420, the network 101 likewise would retrieve historical data for the consumer. Next, the network 101 would collect data with respect to numerous activities of the consumer. At step 430, the network 101 would collect location data in accordance with the method and processes described above. All of the these functions of steps 410-430 preferably are performed by modules within the loyalty server 130.

Concurrently, the network 101 at step 432 would collect activity data related to the specific shopping event being monitored. As discussed herein, the specific activity may include a plurality of actions by the consumer including but not limited to the path of travel of the consumer, the products viewed and examined by the consumer, smart-phone activity of the consumer, etc. At step 434, the network 101 would receive checkout data for the specific shopping event being analyzed.

At step 440, the network 101 will analyzed and organize the data collected at steps 430-434.

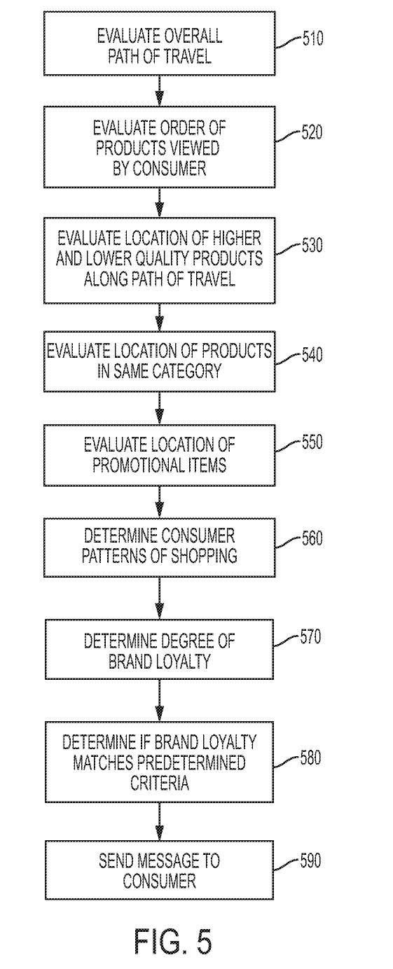

At step 450, the network 101 will compare the consumer's purchased items for the shopping event with historical data related to previously purchased items. In other words, the consumer would check out as the consumer would normally check out of a retail, wholesale, or other relevant store. The system would look at items the consumer's purchases and the system, for each item, would determine at step 460 if the “type” or “category” of product(s) has been purchased by consumer before. (e.g. Cookies, Chips, Soda). If at step 460 the answer is “no,” the system would determine at step 470 that no brand loyalty record exists. If the answer is “yes,” the system would determine at step 480 if the brand viewed but not purchased/picked up has been purchased before. If the brand was never viewed or purchased before, then again the system would proceed to step 470 where it has been determined that no brand loyalty exists. If the brand has been purchased before based on the analysis at step 480, then the system will proceed to evaluate the degree of brand loyalty at step 490. The evaluation process related to brand loyalty is set forth in further detail with reference to FIG. 5.

Next, the loyalty server 130, for each item purchased, would look at the path the consumer travelled relative to, for example:
1. The order of the related products a consumer passes by (e.g. did the consumer buy the first item of this type of food the consumer saw? e.g., the first type of cookie the consumer saw after walking in.);
2. Location of products that are cheaper (e.g. did the consumer see a product that was cheaper?);
3. Location of products that are in the same category (e.g. did the consumer go to the cookie aisle to buy a specific brand or did the consumer just purchase the item on an endcap display?);
4. Location of products that are higher/lower quality;
5. Overall location travelled in store profile (e.g. does a consumer like walking all of the way to the back of the store?)
6. Locations of promotional items in the store (e.g. where the promotional banners are?).

FIG. 5 is a continuation of the flowchart of FIG. 4 further showing steps of a method to evaluate a degree of brand loyalty related to a consumer according to an embodiment of the present invention by mapping the consumer's purchase activities and path of travel to the venue's floorplan. At step 510, the network 101 will evaluate the overall path of travel of the consumer. At step 520, the network 101 will evaluate the order of products viewed by the consumer. At step 530, the network 101 will evaluate the relative location of higher and lower quality products along the consumer's path of travel during the shopping event. Comparing the purchased product to the consumer historical data, the network 101 at step 540 will evaluate the location of products in the same category. At step 550, the network 101 will determine and evaluate the location of promotional items relative to the product(s) purchased by the consumer.

Based on the collected data as evaluated at steps 510-550, the network 101 would determine whether any shopping patterns exist at step 560. Patterns are based on the reoccurrence of the same fact pattern or similar fact patterns over time.

Next, at step 570 the loyalty server 130 will determine a degree of brand loyalty. For example, if a consumer is consistent on the way the consumer determines the product the consumer purchases, the loyalty server 130 would determine there is an increase confidence on brand loyalty. If consumer is not consistent in the way the consumer determines the product the consumer purchases, the loyalty server 130 would determine there is a decrease confidence on loyalty. In other words, the loyalty server 130 next evaluates trends when the network 101 evaluates the current shopping experience with the historical data. Based on a variety of factors, the loyalty server 130 would compare the degree of brand loyalty with predetermined criteria at step 580 to determine if the consumer's degree of brand loyalty warrants a promotional message or reward benefit. The predetermined criteria is a customizable factor determined by the merchant such as consumer consistency in purchasing a particular type of product, a particular price point, quality of product, a consumer's tendency to purchase products subject to a promotion, and other factors relevant to marketing campaigns of the merchant or seller.

In accordance with this invention, a multi-brand loyalty server 130 provides real-time product or service suggestions to consumers based on transaction data coupled with location data. The multi-brand loyalty server receives consumer location information and transaction data from consumer history. A loyalty event, such as a promotion, a specific advertisement, or reward for a suggested product or service, is determined based on the transaction data. Information about a suggested merchant and the loyalty event is sent to a remote or mobile device operated by the consumer at step 590 in order to encourage him to make a purchase from the suggested merchant.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

In embodiments, the computer or computer system may be or include a special-purpose computer or machine that comprises specialized, non-generic hardware and circuitry (i.e., specialized discrete non-generic analog, digital, and logic based circuitry) for (independently or in combination) particularized for executing only methods of the present invention. The specialized discrete non-generic analog, digital, and logic based circuitry may include proprietary specially designed components (e.g., a specialized integrated circuit, such as for example an Application Specific Integrated Circuit (ASIC), designed for only implementing methods of the present invention).

In embodiments, the determining degree of brand loyalty may be implemented using special purpose algorithms. For example, a special purpose algorithm may be implemented to compare a current shopping event and historical data from previous shopping events. Similar data between the current and past shopping events may identify patterns of the travel and circumstances related to brand loyalty, which through the special purpose algorithm allow a degree of brand loyalty to be determined based on data collected by the system. In embodiments, a special purpose algorithm analyzing consumer tendency in a path of travel, in purchasing a particular type of product, a particular price point, quality of product, a consumer's tendency to purchase products subject to a promotion, and other factors relevant to marketing campaigns of the merchant or seller, and/or any other industry specific attributes that would be obvious to one of ordinary skill in the art.

The present invention provides consumer data to marketing agents who create marketing campaigns according to established techniques. Consumer data is critical to the marketing analysis. The ability for retail, wholesale and other consumer-based institutions to acquire new consumers, and cross-sell and upsell products to existing consumers, is entirely dependent on how well the institutions know the consumer(s). Factors such as “who they are?;” “what products they like?;” “what offers are most likely to resonate with them?;” “how can one better measure the effectiveness of marketing campaigns and quickly make changes and improve results?:” and having an accurate and up-to-date comprehensive view of consumer data is the most effective way to effectively analyze existing data points, personalize interactions, and predict response to guide future interactions. The path a consumer travels throughout a store likewise plays an important role in evaluating consumer demand and affinity for certain products and brands.

As simple as it sounds, knowing one's consumer can be a complex challenge, particularly as it relates to marketing campaigns. Brand affinity and loyalty are all rooted in consumer data. Being able to see who the consumers are, what products and services the consumers have or may be interested in and how offerings relate to consumer profiles are all essential to efficient and effective campaigns.

Ideally, one's data management environment should provide clean, accurate and consistent data to any marketing campaign tools. Additionally, the data should enable one's marketing team to effectively analyze the results of any campaign and other marketing activity. Finally, by capturing insights into consumer behavior from the campaigns, an effective data management environment should increase the velocity and effectiveness of marketing campaigns.

The inquiry does not just stop at consumer buying data; it also includes a consumers path of travel throughout a venue. New product introductions, new product and service bundles, different products by market and store location also require accurate location data so one can maximize campaign effectiveness. It is therefore just as important to be able to integrate and correlate results with consumer and campaign information.

The present invention is designed to provide marketing agents with comprehensive and accurate data related to the correlation of a consumer's shopping habits, specifically as it relates to the consumer's path of travel and specific locations within brick-and-mortar stores. Such data will provide unique benefits to all levels of marketing campaigns.

Any combination of one or more computer readable medium(s) may be utilized to achieve the benefits of the present invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

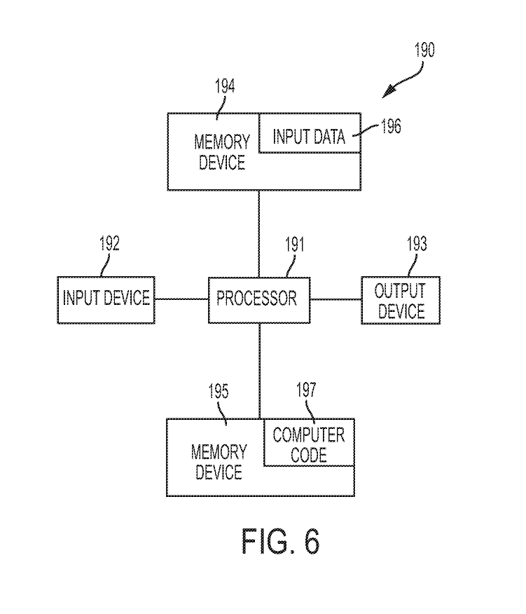

FIG. 6 illustrates a computer system 190 used for implementing the methods of the present invention. The computer system 190 includes a processor 191, an input device 192 coupled to the processor 191, an output device 193 coupled to the processor 191, and memory devices 194 and 195 each coupled to the processor 191. The input device 192 may be, inter alia, a keyboard, a mouse, etc. The output device 193 may be, inter alia, a printer, a plotter, a computer screen, a magnetic tape, a removable hard disk, a floppy disk, etc. The memory devices 194 and 195 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 195 includes a computer code 197 which is a computer program that includes computer-executable instructions. The computer code 197 includes software or program instructions that may implement an algorithm for implementing methods of the present invention. The processor 191 executes the computer code 197. The memory device 194 includes input data 196. The input data 196 includes input required by the computer code 197. The output device 193 displays output from the computer code 197. Either or both memory devices 194 and 195 (or one or more additional memory devices not shown in FIG. 6) may be used as a computer usable storage medium (or program storage device) having a computer readable program embodied therein and/or having other data stored therein, wherein the computer readable program includes the computer code 197. Generally, a computer program product (or, alternatively, an article of manufacture) of the computer system 190 may include the computer usable storage medium (or said program storage device).

The processor 191 may represent one or more processors. The memory device 194 and/or the memory device 195 may represent one or more computer readable hardware storage devices and/or one or more memories.

Thus the present invention discloses a process for supporting, deploying and/or integrating computer infrastructure, integrating, hosting, maintaining, and deploying computer-readable code into the computer system 190, wherein the code in combination with the computer system 190 is capable of implementing the methods of the present invention.

While FIG. 6 shows the computer system 190 as a particular configuration of hardware and software, any configuration of hardware and software, as would be known to a person of ordinary skill in the art, may be utilized for the purposes stated supra in conjunction with the particular computer system 190 of FIG. 6. For example, the memory devices 194 and 195 may be portions of a single memory device rather than separate memory devices.

It is understood in advance that although this disclosure includes a detailed description on conventional networks and cloud computing networks, implementation of the teachings recited herein are not limited to any particular computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization and may be managed by the organization or a third party and may exist on-premises or off-premises.

Community cloud: the cloud infrastructure is shared by several organizations and supports a specific community that has shared concerns (e.g., mission, security requirements, policy, and compliance considerations) and may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

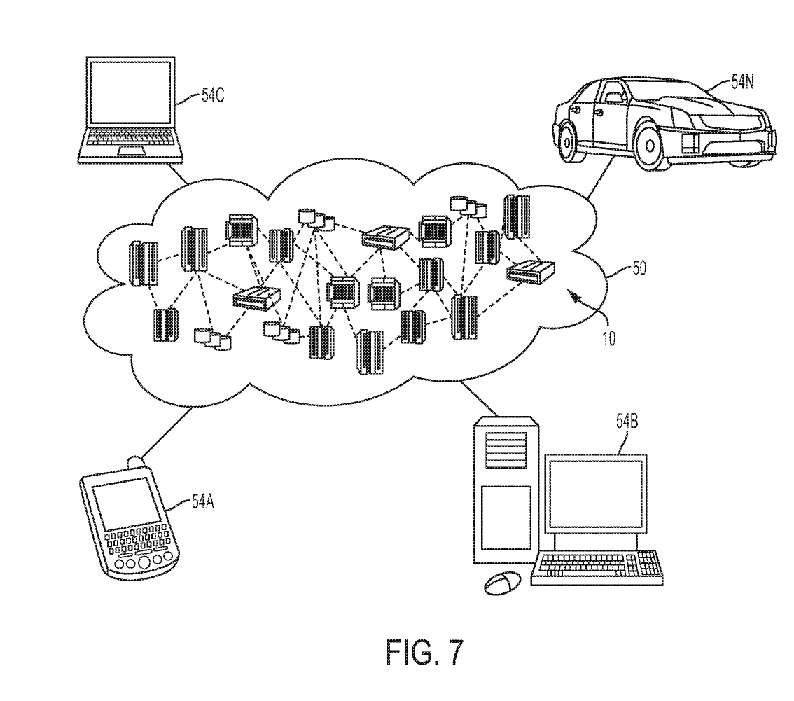

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another and may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

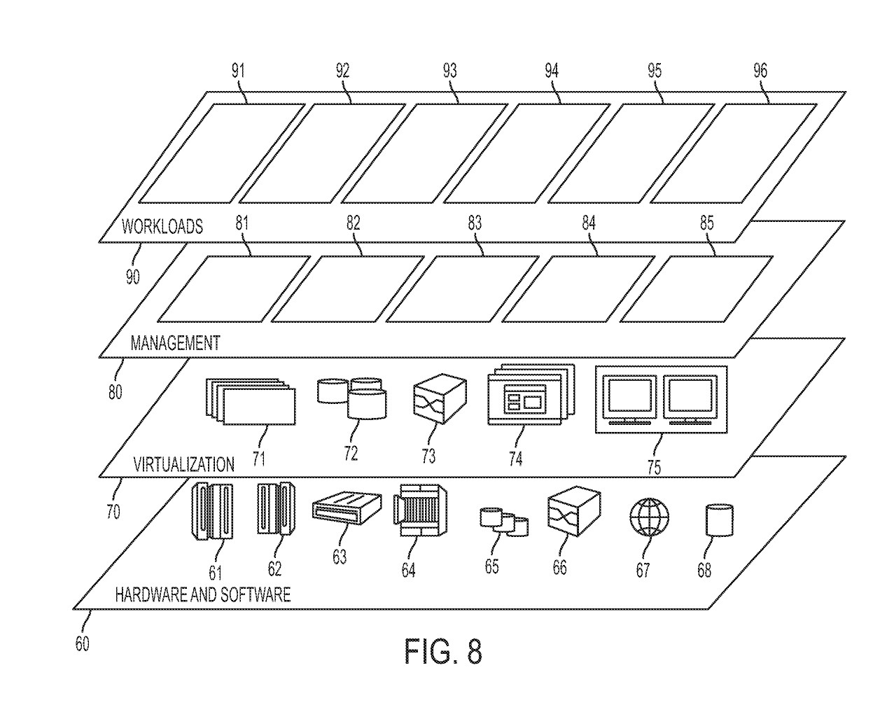

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the system 96 to determine brand loyalty using location and micro-location detection according to the present invention.

Conventional data acquisition is typically hampered by a marketing agent's inability to match the consumer's location data with various locations of the shopping venue having assigned values to determine customer brand loyalty or brand affinity. Additionally, conventional consumer data acquisition systems fail to provide individually customizable filtering of consumer data by taking advantage of the technical capability of certain communication networks including location tracking systems and venue floorplans. The present invention will map the consumer's path of travel throughout a venue with the venue's floorplan with specific value assigned to location throughout. Moreover, conventional systems fail to weigh different locations throughout the venue which cannot be accomplished by a computer alone.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of determining brand loyalty based on user location, the method comprising:
determining, by a computer, a pattern of shopping for a user including specific locations of said user within a venue during a shopping event;
receiving, by the computer, purchase data indicative of items purchased by the user during said shopping event;
cross-referencing, by the computer, said purchase data with said pattern of shopping;
determining, by the computer, that the user has a degree of brand loyalty based, at least in part, on the step of cross-referencing, wherein said degree of brand loyalty is a calculated score that varies based at least in part on said specific locations of said user within said venue during said shopping event; and
sending output indicative of the degree of brand loyalty to a marketer for developing a marketing campaign based on said degree of brand loyalty of said user.

2. The method of claim 1, further comprising:
determining, by the computer, that the degree of brand loyalty has met at least one criteria that dictates that a message is to be sent to the user; and
sending, by the computer, the message to the user, wherein the message is configured based, at least in part, on the degree of brand loyalty.

3. The method of claim 1, further comprising:
determining a pathway within a venue that was taken by the user during said shopping event, said pathway comprising a series of specific locations within said venue; and
determining the pattern based, at least in part, on the pathway.

4. The method of claim 3, further comprising:
assigning values to said specific locations along the pathway during the shopping event, said values determining, at least in part, said calculated score.

5. The method of claim 3, further comprising:
determining location of promotional items placed along the pathway in said venue of said shopping event.

6. The method of claim 3, further comprising:
receiving data related to specific products provided at said specific location along the pathway within the venue traversed by the user during said shopping event; and
sending said message including promotional items based on said pathway in said venue of said shopping event.

7. The method of claim 3, further comprising:
mapping said pathway to a floorplan of said venue to identify affinity zones where said user's pattern of shopping showed tendencies toward specific actions that were repeated; and
comparing said calculated score to a predetermined value, said comparing being used, at least in part, to perform said step of determining that the degree of brand loyalty has met at least one criteria that dictates that said marketing campaign is targeted to the user.

8. The method of claim 1, further comprising:
comparing current purchase data by the user with previous purchase data for the user;
determining that the current purchase data matches at least in part with the previous purchase in the previous purchase data stored by the computer.

9. The method of claim 1, wherein said step of determining that the degree of brand loyalty has met said at least one criteria includes comparing a current purchase by the user with previous purchase data for the user and determining that a brand for the current purchase matches with a previous brand in the previous purchase data stored by the computer.

10. A computer program product comprising:
a computer-readable storage device; and
a computer-readable program code stored in the computer-readable storage device, the computer readable program code containing instructions executable by a processor of a computer system to implement a method to send a message based on brand loyalty, the method comprising:
determining a pattern of shopping for a user including specific locations of said user within a venue during a shopping event;
receiving purchase data indicative of items purchased by the user during said shopping event;
cross-referencing said purchase data with said pattern of shopping;
determining that the user has a degree of brand loyalty based, at least in part, on the step of cross-referencing, wherein said degree of brand loyalty is a calculated score that varies based at least in part on said specific locations of said user within said venue during said shopping event; and
sending output indicative of the degree of brand loyalty to a marketer for developing a marketing campaign based on said degree of brand loyalty of said user.

11. The computer program product of claim 10, said method further comprising:
determining that the degree of brand loyalty has met at least one criteria that dictates that a message is to be sent to the user; and
sending the message to the user, wherein the message is configured based, at least in part, on the degree of brand loyalty.

12. The computer program product of claim 10, said method further comprising:
determining a pathway within a venue that was taken by the user during said shopping event, said pathway comprising a series of specific locations within said venue; and
determining the pattern based, at least in part, on the pathway.

13. The computer program product of claim 12, said method further comprising:
assigning values to said specific locations along the pathway in said venue of the shopping event.

14. The computer program product of claim 10, said method further comprising:
comparing current purchase data by the user with previous purchase data for the user;
determining that the current purchase data matches at least in part with the previous purchase in the previous purchase data stored by the computer.

15. A computer system, comprising:
a processor;
a memory coupled to said processor; and
a computer readable storage device coupled to the processor, the storage device containing instructions executable by the processor via the memory to implement a method to send a message based on brand loyalty, the method comprising the steps of:
determining a pattern of shopping for a user including specific locations of said user within a venue during a shopping event;
receiving purchase data indicative of items purchased by the user during said shopping event;
cross-referencing said purchase data with said pattern of shopping;
determining that the user has a degree of brand loyalty based, at least in part, on the step of cross-referencing, wherein said degree of brand loyalty is a calculated score that varies based at least in part on said specific locations of said user within said venue during said shopping event; and
sending output indicative of the degree of brand loyalty to a marketer for developing a marketing campaign based on said degree of brand loyalty of said user.

16. The computer system of claim 15, said method further comprising:
determining that the degree of brand loyalty has met at least one criteria that dictates that a message is to be sent to the user; and
sending the message to the user, wherein the message is configured based, at least in part, on the degree of brand loyalty.

17. The computer system of claim 15, said method further comprising:
determining a pathway within a venue that was taken by the user during said shopping event, said pathway comprising a series of specific locations within said venue; and
determining the pattern based, at least in part, on the pathway.

18. The computer system of claim 17, said method further comprising:
assigning values to said specific locations along the pathway in said venue of the shopping event.

19. The computer system of claim 17, said method further comprising:
mapping said pathway to a floorplan of said venue to identify affinity zones where said user's pattern of shopping showed tendencies toward specific actions that were repeated; and
comparing said calculated score to a predetermined value, said comparing being used, at least in part, to perform said step of determining that the degree of brand loyalty has met at least one criteria that dictates that said marketing campaign is targeted to the user.

20. The computer system of claim 15, said method further comprising:
comparing current purchase data by the user with previous purchase data for the user;
determining that the current purchase data matches at least in part with the previous purchase in the previous purchase data stored by the computer.
